(19) United States
(12) Patent Application Publication
(10) Pub. No.: US 2006/0085741 A1
(43) Pub. Date: Apr. 20, 2006

(54) Method and apparatus to view multiple web pages simultaneously from network based search

(75) Inventors: Scott P. Weiner, Fort Lauderdale, FL (US); Michael B. Birnholz, Oakland Park, FL (US)

Correspondence Address: BEYER WEAVER & THOMAS LLP, P.O. BOX 70250, OAKLAND, CA, 94612-0250, US

(73) Assignee: VIEWFOUR, INC. A DELAWARE CORPORATION, FORT LAUDERDALE, FL (US)

(21) Appl. No.: 10/970,676

(22) Filed: Oct. 20, 2004

(51) Int. Cl. G06F 17/00

(52) U.S. Cl. 715/517

(57) ABSTRACT

A graphical user interface for displaying at least two search results from a plurality of search results identified during a network based search. The graphical user interface includes a first window configured to display a first web page that is associated with a first search result of the plurality of search results. In the first window displaying the first web page, a user may independently scroll through and view content contained thereon. The GUI further includes a second window configured to display a second web page that is associated with a second search result of the plurality of search results. In the second window, the user may also independently scroll through and view content contained on the second web page. By simultaneous viewing of multiple websites, the user can easily decide whether to further their search and click through to the corresponding website.

### FIELD OF THE INVENTION

The present invention relates to network based search engines, and more particularly, relates to graphical interfaces adapted to present network based search results in a customizable multiple web page window format.

### DESCRIPTION OF THE RELATED ART

Despite the Internet's recent origin, this medium has rapidly become an important source of information for individuals and businesses. The popularity of the Internet as an information source is due, in part, to the vast amount of available information that can be accessed by almost anyone having access to a computer and a modem. One of the Internet's strength lies in its open-ended nature since it is not supervised or controlled by any person or entity. These and other factors have caused an exponential increase in Internet usage and with it, an exponential increase in the volume of information available.

To retrieve and locate these vast, almost limitless, resources of information, search engines have been developed to aid users. Using prominent search terms for any particular subject, these search engines will locate related subject matter containing such terms, as well as advertiser's websites, many of which pay the search engines to have their sites located at or near the top of the list of web pages included in the search results. Typical of the more prominent search engines include those available on Google.com, Yahoo.com, and MSN.com. These and other search engine technologies permit users to search narrower and/or other categories of information as well. For example, Yahoo permits users categorical searches such as images, news, and various products for sale. Clients can also search a variety of categories of the web content organized by topic (e.g., art, business, computers, science, shopping, sports, etc) or various subcategories of content (e.g. on-line mail order catalogs). Many web sites include features that permit users to search for terms (keywords) used in their web site content and others allow users to search additional databases (such as a database of text from books, music etc.).

Briefly, in a web-based search on an internet search engine or search provider, a user enters a search term comprising of one or more keywords, which the search engine then uses to generate, in real time, a search result list of many web pages that the user may access via a hyperlink. The search engines and web site directories typically rely upon methodologies for assigning results to keywords that often generate irrelevant search results. The automated indexing technology that drives many search engines rely in large part on complex, mathematics-based database search algorithms that select and rank web pages based on multiple criteria such as keyword density and keyword location, including but not limited to links from other pages as well as external pages.

The search results generated by such mechanisms often rely on blind mathematical formulas and may be random and even irrelevant. In addition, search engines that use automated search technology to catalog search results generally rely on invisible web site descriptions, or “meta tags”, that are authored by web site promoters. Web site owners may freely tag their sites as they choose, and can exploit such tags to increase website traffic. Consequently, some web site promoters insert popular search terms into their web site meta tags which are not relevant because by doing so they may attract additional consumer attention at little to no marginal cost. Finally, many web sites have similar meta tags, and the search engines are simply not equipped to prioritize results in accordance with consumers' preferences.

Virtually all of these popular search engines display the search results in a textual list format, the content of which is based upon the user's selected keyword search. An example of such a list 10 of search results is provided in FIG. 1. As shown, the textual content in each of the returned results in the list 10 is often uninformative and nonsensical since the majority of the descriptions are but mere textual snippets 11 of the sample text from the website that contain the selected keyword. Moreover, the textual snippets 11 are typically fragmented and often displayed in mid-sentence form. This is due to the automated process the search engines perform when collecting websites for their indexes that are often less than 250 characters in length.

Once a list 10 of search results are displayed on the screen, the user typically must read each textual snippet 11 to determine its relevance. Reading this often fragmented, nonsensical text collectively takes time, and most users simply scan the page for what appears to be a good match or click just the first few listings hoping to find what they are looking for. Since the user cannot determine the relevance from this text, in most instances, they typically open the web page by clicking on the associated link. If the web page is not relevant or of lesser relevance to the user's search, they generally have to hit their “Back” button and then select another result from the previous result list 10. Google, Yahoo, AOL, MSN and all of the other search engines currently function in this manner. Some lesser known search engines have features that attempt to improve this process; however, their results are always in the form of a textual list. Consequently, from a searchers standpoint, a great amount of time is wasted sifting through non-relevant web pages and subject matter.

Moreover, many of the popular search engines incorporate a Pay Per Click (PPC) advertising model for revenue generation. In this advertising model, a ‘visit’ is charged to the advertiser when an actual web surfer enters a keyword and clicks through to an Advertisers website. In a typical PPC environment, the highest bidders are listed first in text search results list in descending order of the highest bidder first, and thus are more likely to be selected by the researcher (i.e., “clicked on”). The ranking of search results list give preference to PPC advertisers as they are more likely to pay a higher price for their listing with results being more relevant as well. Typical of such an advertising model is described in U.S. Pat. No. 6,269,361.

Either way, it is beneficial for the search engine company to have their users open as many advertiser's web pages as possible to increase revenue from the advertisers. In essence, the textual snippet 11 of the search results list tempts the user to click through to the website, whether or not the website is relevant to the user's search.

While these searching techniques and advertising models are beneficial to the search engine providing the advertising, for the advertiser, this normally results in a low conversion rate (clicks to sales) since the researcher may have been unable to obtain much information about the site he was about to visit from the basic text displayed. In other words, the advertiser has to pay the search engine provider for the user's “click” even though the user will not likely purchase anything from the advertiser's website. This advertising model is also not as beneficial to the end user (i.e., the searcher) since they are required to unnecessarily sift through much more content than is relevant to their search.

In view of the foregoing, it would be desirable to improve the conversion rate of the search results for advertisers, while at the same time improve the searching efficiency for the user.

### SUMMARY OF THE INVENTION

The present invention enables the simultaneous multiple display, on a single browser window, of the hyperlinked web pages corresponding to the results returned in a user initiated network based search. A graphical user interface is provided that contains multiple windows that allow respective web pages to be displayed thereon, each web page of which corresponds to a search result uncovered during a network based search by a search provider. Accordingly, rather than reviewing a mere list of snippets of text, a user can simultaneously view and scroll the content of the multiple web pages before deciding whether further navigation is necessary, and physically “clicking” on the web page to open the corresponding website.

More specifically, in one specific embodiment, a graphical user interface is provided for displaying at least two search results from a plurality of search results identified during a network based search. The graphical user interface includes a first window configured to display at least a first viewing portion of a first web page associated with a first search result of the plurality of search results. The GUI further includes a second window configured to display at least a second viewing portion of a second web page associated with a second search result of the plurality of search results. The first viewing portion and the second viewing portion each comprise at least a predetermined width and height of a browser window based upon the resolution of the user's screen.

In one specific embodiment, the first and second viewing portions comprise the upper left corner of the corresponding of the first and second web pages. Further, the predetermined width is in the range of at least about 400 pixels to about 700 pixels, and the predetermined height is in the range of at least about 100 to about 240 of the height of the browser window.

In another configuration, the first window is configured to enable the user to independently scroll through and view the remaining content contained on the first web page. Further, the second window is configured to enable the user to independently scroll through and view the remaining content contained on the second web page.

In yet another embodiment, a third window is configured to display at least a third first viewing portion of a third web page associated with a third search result of the plurality of search results, wherein the third viewing portion being sufficiently sized to enable the user to substantially determine the generally search relevancy of the third search result. Further, a fourth window is configured to display at least a fourth viewing portion of a fourth web page associated with a fourth search result of the plurality of search results, wherein the fourth viewing portion being sufficiently sized to enable the user to substantially determine the generally search relevancy of the fourth search result.

In another aspect of the present invention, a graphical user interface is disclosed for simultaneous display of at least two websites associated with search results identified during a network based search. The graphical user interface includes a quantity selector enabling a user to select the number of windows for the simultaneous display of the at least two websites corresponding to the selected number. The interface further includes the selected number of windows each configured for display of a web page associated with a corresponding search result, wherein a user may independently scroll through and view the content contained on each web page.

In one arrangement, the quantity selector being configured to enable the user to select up to ten independent windows for the simultaneous display. The quantity selector is further in the form of a pull-down menu.

In yet another embodiment, at least four independent windows are simultaneously displayed. The windows are arranged in one of adjacent columns and adjacent rows, the interface further comprising one of at least one column delimiter and at least one row delimiter that visibly marks the boundaries between adjacent windows.

In yet another configuration, each window includes at a vertical scroll bar when the corresponding window is of an insufficient size to display the entire vertical content of the corresponding web page, and at a horizontal scroll bar when the corresponding window is of an insufficient size to display the entire horizontal content of the corresponding web page.

In still another aspect of the present invention, a graphical user interface for displaying at least two search results from a plurality of search results identified during a network based search. The user interface includes a first window configured to display a first web page associated with a first search result of the plurality of search results. A second window is configured to display a second web page associated with a second search result of the plurality of search results. In both the first and second windows, the user may independently scroll through and view content contained on the web pages.

Another aspect of the present invention includes a computer implemented method for displaying search results on a client system, the client system of which is in connection to a computer network. The computer network includes at least one content provider server and at least one intermediate server. The method includes receiving a search request from the client system, the search request including at least one search term relating to a search topic, and processing the search request that includes retrieving search results. The search results include a plurality of URLs corresponding to a plurality of web pages. The method further includes providing a first portion of the search results to the client system, the first portion including a first portion of URLs of the plurality of URLs. The method includes causing the client system to retrieve web page content associated with a first portion of URLs of the plurality of URLs; and causing the client system to display, via a graphical user interface, the search results according to a first specified format. The first specified format includes a plurality of windows, each window displaying web page content associated with a respective web page of the first portion of URLs.

In still another aspect, a system is disclosed for displaying search results on a client system. The system includes at least one processor, at least one interface configured or designed to provide a communication link to at least one other network device in the data network; and memory. The system is configured to receive a search request from the client system, the search request including at least one search term relating to a search topic, and process the search request. The processing of the search request includes retrieving search results that include a plurality of URLs corresponding to a plurality of web pages. The system is further configured to provide a first results portion of the search results to the client system. The first results portion of search results includes a first portion of URLs of the plurality of URLs. The system is further configured to cause the client system to retrieve web page content associated with a first portion of URLs of the plurality of URLs; and cause the client system to display, via a graphical user interface, the search results according to a first specified format. The first specified format includes a plurality of windows, each window displaying web page content associated with a respective web page of the first portion of URLs.

In yet another specific embodiment, a computer program product is provided for displaying search results on a client system. The computer program product includes a computer usable medium having computer readable code embodied therein. The computer readable code includes computer code for receiving a search request from the client system, the search request including at least one search term relating to a search topic, and computer code for processing the search request. The processing of the search request includes retrieving search results, the search results including a plurality of URLs corresponding to a plurality of web pages. The program product further includes computer code for providing a first results portion of the search results to the client system. The first results portion includes a first portion of URLs of the plurality of URLs. The program product includes computer code for causing the client system to retrieve web page content associated with a first portion of URLs of the plurality of URLs; and computer code for causing the client system to display, via a graphical user interface, the search results according to a first specified format. The first specified format includes a plurality of windows, each window displaying web page content associated with a respective web page of the first portion of URLs.

Lastly, a method is provided for displaying computerized search results from a network based search on a user's display device. The method includes receiving a search request from a searcher, and performing a search, based upon the search request, to obtain a plurality of search results, each search result being associated with a corresponding web page. Simultaneously displaying on the display device at least two windows each containing a web page corresponding to an associated search result from the search.

The method, in one configuration, includes receiving user scrolling instructions to independently enable scrolling through and viewing content contained on the respective displayed web page. The method further includes receiving user page advance instructions to selectively advance the content displayed in the at least two windows to a next set of web pages, each corresponding to a next set of associated search results from the search.

In one specific embodiment, the method further includes introducing a vertical scrolling tool when the corresponding window is of an insufficient size to display the entire vertical content of the corresponding web page, and introducing a horizontal scrolling tool when the corresponding window is of an insufficient size to display the entire horizontal content of the corresponding web page.

In another embodiment, arranging the windows in one of adjacent columns and adjacent rows, and positioning at least one adjustable column delimiter and at least one adjustable row delimiter that visibly marks the boundaries between adjacent windows. The method of this embodiment further includes before the receiving a search request, enabling the user to select the number of windows for the simultaneous display on the display device. The enabling the user further includes receiving a user selection input from the user.

These and other features of the present invention will be described in more detail below in the detailed description of the invention and in conjunction with the following FIGURES.

### BRIEF DESCRIPTION OF THE DRAWINGS

FIG. 1 is an exemplary search result for a keyword search conducted at GOOGLE™ an Internet search engine.

FIG. 2 is an exemplary Graphical User interface (GUI) in accordance with the present invention that may be used by a consumer to simultaneously display the websites corresponding to the first four search results of a search in four independent display windows of one browser window.

FIG. 3 is an exemplary browser window opened upon clicking on the first window in the GUI of FIG. 2.

FIG. 4 is an exemplary GUI that may be used by a consumer to initiate a search for the display of the results in the GUI of FIG. 2.

FIGS. 5A and 5B are a series of exemplary alternative GUIs of that in FIG. 2 that may be used by a consumer to simultaneously display six windows in one browser window.

FIG. 6 is the exemplary GUI of FIG. 2 illustrating the ability to independently view and scroll the content of the website from a display window.

FIG. 7 is the exemplary GUI of FIG. 2 illustrating the ability to independently increase the width and height of the display windows.

FIG. 8 is a block diagram depicting a search results display method for the GUI of FIG. 2.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

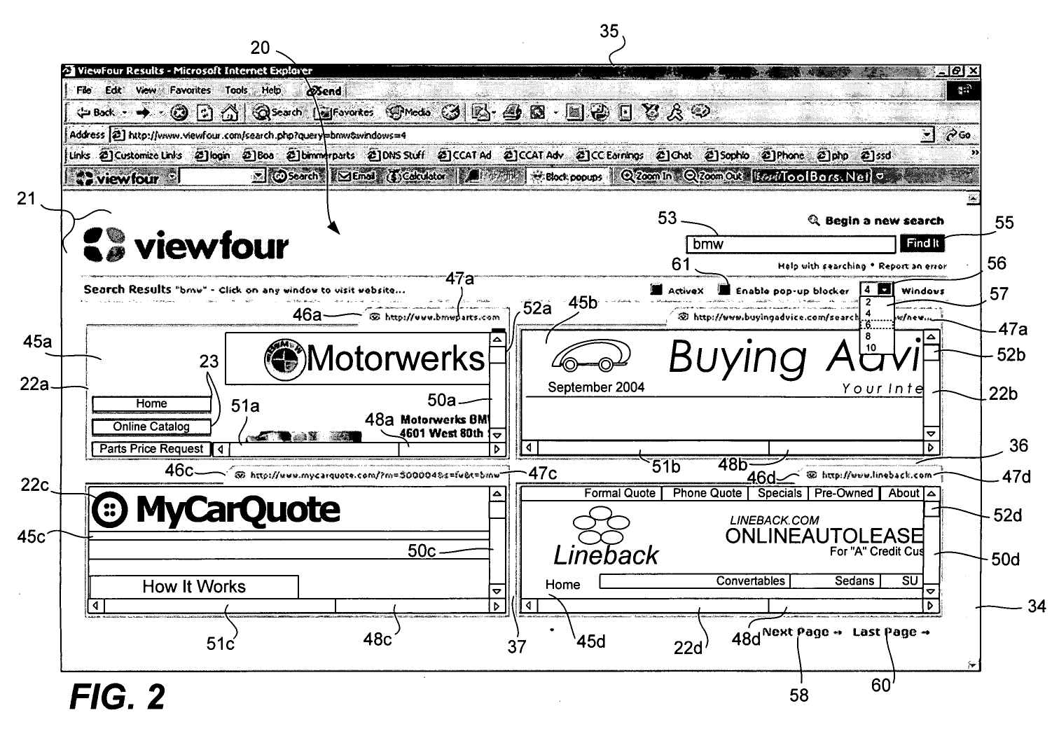

Referring now to FIG. 2, the present invention provides a Graphical User interface (GUI) or Visual User interface (VUI), generally designated 20, for displaying at least two search results from a plurality of search results identified during a computerized network based search (e.g., an internet based search). FIG. 2 represents a search results page 21 of the graphical user interface 20 includes a first window 22a configured to graphically display at least a first viewing portion 45a of a first web page, associated with a first search result of the plurality of search results. In the same graphical user interface 20, a second window 22b configured to graphically display at least a second viewing portion 45b of a second web page associated with a second search result of the plurality of search results. In accordance with the present invention, the first and second viewing portions each comprise at least a predetermined width and height of a browser window based on the screen size (resolution) of the user's terminal.

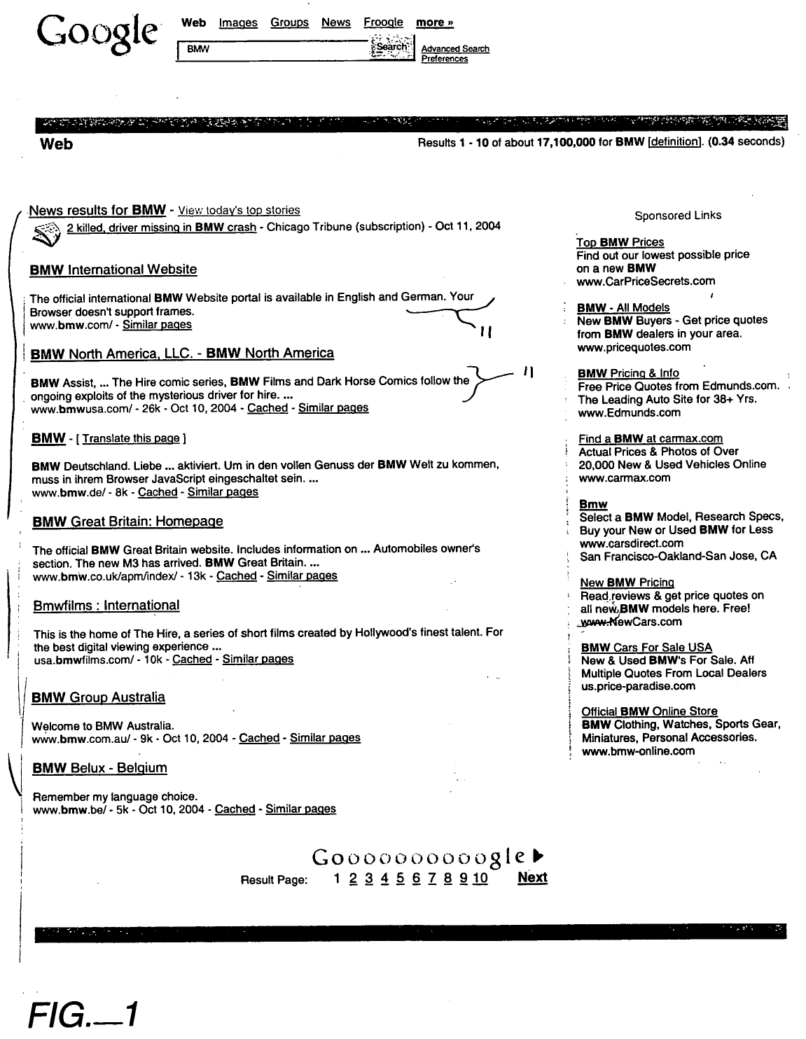

Accordingly, a multi-window graphical user interface and system are provided that enable the simultaneous display, on a single browser window, of at least two hyperlinked web pages corresponding to the results returned in a user initiated network based search performed by a search provider. Unlike the current search technology which generally returns a list 10 of snippets 11 of the meta tag content from a corresponding website accessed via a hyperlink (e.g., a Google search listed in FIG. 1), the GUI of the present invention displays multiple windows containing the actual website corresponding to the results of the search. Hence, this search result framework allows a user to easily and intuitively review, in a multiple window format, the actual web pages corresponding to the search results before deciding whether to further their search and click through to the corresponding website.

This arrangement is advantageous to both a search user and an advertiser in many ways. For instance, a user can immediately, visually observe and independently view the content of the actual underlying website corresponding to the selected search. By enabling the simultaneous display of multiple websites, the user can very quickly view and determine their relevance with little or no reading of the site description. Hence, the user's search efficiency is dramatically improved.

In the current search result lists, by comparison, a web surfer has to read through the short, nonsensical list of contextual snippets. To determine their actual relevancy, however, they must click through the corresponding hyperlink, and visit each site. Should the site not be relevant or deemed inadequate, the surfer would have to manipulate the “back” button to return to the search results list, and then repeat the steps again to view another site.

From the Advertiser's view, in a Pay Per Click (PPC) model where the advertiser pays when the user opens their website directly from the search results, the present invention is also advantageous in that the number of irrelevant click-throughs is reduced. Since the user can preview the web page before deciding to further investigate (i.e., open the website), the Advertiser may not have to pay the search provider in instances were the user determines the previewed website is non-relevant. Hence, the Advertiser can increase their conversion rates (clicks to sales) substantially.

In one specific embodiment, as mentioned, each viewing portion 45a-45d of the respective window 22a-22d is at least a predetermined width and at least a predetermined height of the browser window. It will be appreciated that these values are selected of a sufficient dimension to enable the user to substantially determine the generally search relevancy of content displayed. In other words, the viewing portion is sufficiently sized and placed so that the user will be able to view a sufficient portion of the displayed web page to generally determine what the content is of the website being displayed. From this, they will be able to quickly determine whether to click through to the underlying website. In accordance with the present invention, in one specific embodiment, the predetermined width of the body portion of each display window 22a-22d is in the range of at least about 400 to 700 pixels wide. Further, the predetermined height of the body portion is in the range of at least about 100 to 240 pixels high.

Moreover, the position of the viewing portions 45a-45d are located in the upper left corner of the corresponding of the first and second web pages. At this region, most web site designers begin the website content such as the name of the website itself. Hence, by placing the viewing portions at this location, the user is more likely to be able to determine what the underlying website is, and it relevance to the user's search.

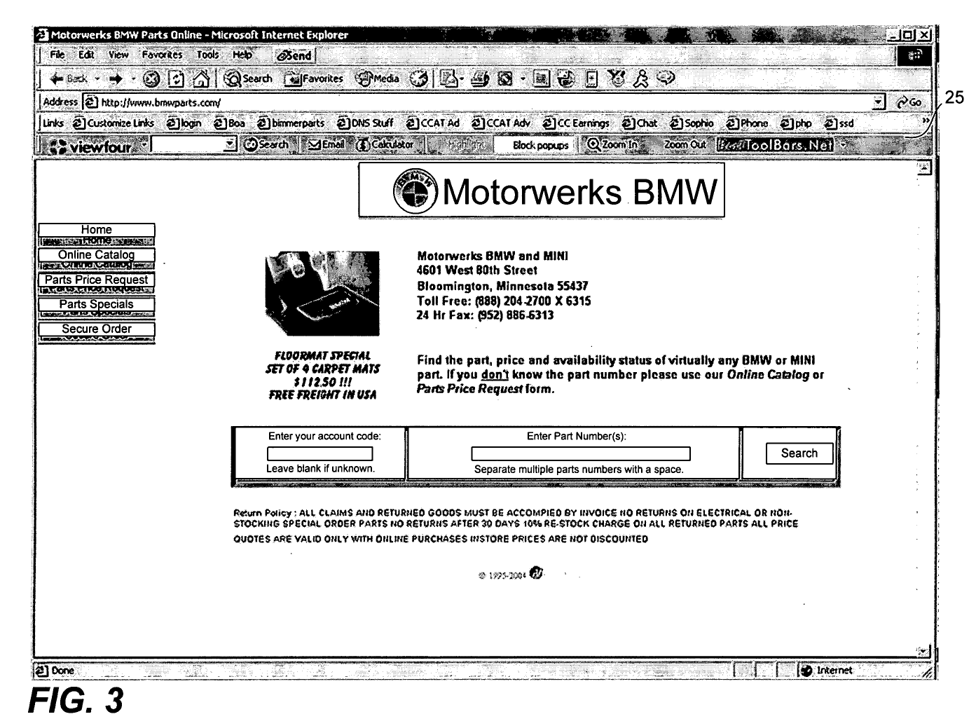

In accordance with the present invention, the web pages presented in the display windows 22a-22d of the VUI 20 are the actual pages found at the website. However, the interior hyperlinks (e.g., button 23 in FIG. 2) are masked in order to prevent further navigation without a corresponding click-through. Hence, attempting to click on one of the buttons 23 from the corresponding window will allow a click through to the underlying webpage of the associated search result. As shown in FIG. 3, the website contained in the browser is directed to that underlying webpage that contains the keyword searched for.

This graphical display only format for the website is beneficial to both Advertiser and the search providers since it would otherwise be difficult to determine whether the search provider was responsible for the direction of the user to the advertiser's website. In search engine models, where advertisers are able to determine their ranking, the advertiser pays the search provider an amount each time a user enters the advertiser's website directly from the search engine result page.

It will be appreciated, however, that in other specific embodiments, the user may be permitted to navigate the displayed web page, and manipulate the buttons 23 displayed in each window. For instance, in a website displayed in one of the display windows, any user clicking on a hyperlink will be directed to the page associated with the hyperlink.

Briefly, those familiar with web and website based searching have likely used at least one of the well known search engines which include GOOGLE™, ASKJEEVES™, YAHOO™, AOL™ and MSN™, to name a few. In general, however, search engines are becoming more powerful and capable of returning more relevant results than in the past. The Graphical User interface (GUI) or Visual User interface (VUI) 20 to be described is particularly well suited for use in some of these more powerful search systems and systems that are capable of returning context sensitive results that may be more pertinent to the user.

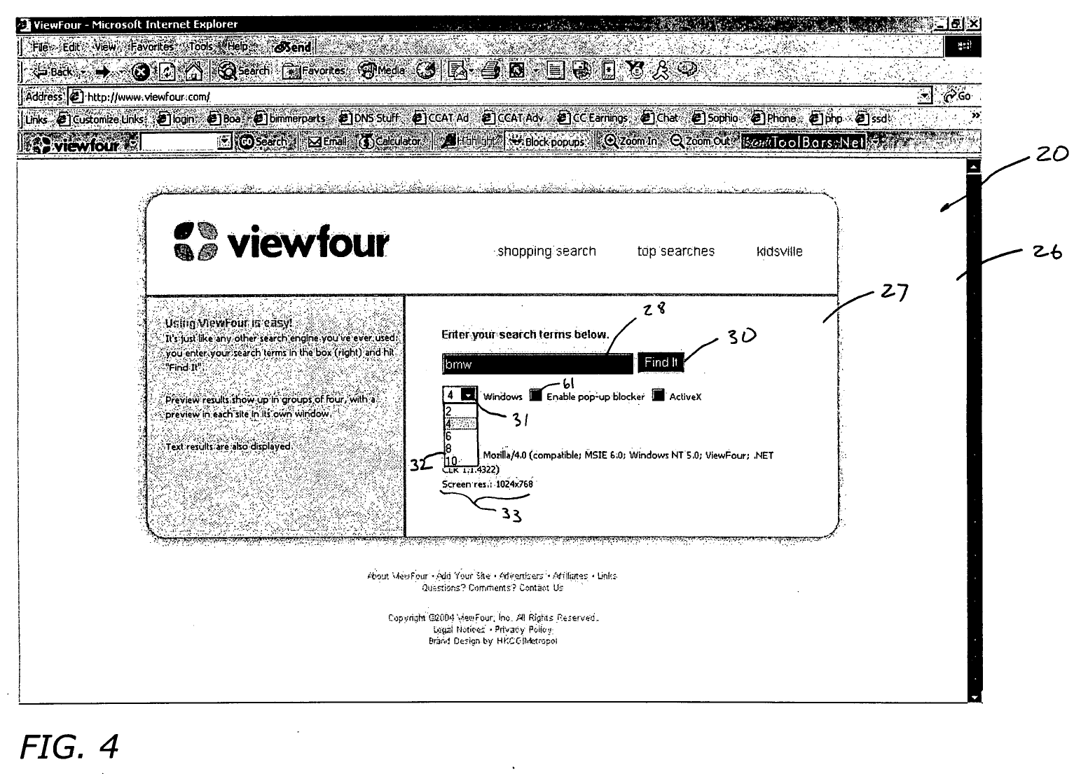

Turning now to FIG. 4, in one specific configuration, an initial home page 26 is displayed that enables a search, using the VUI 20 of the present invention, to commence. The home page 26 includes a search commencement region 27 that further provides a conventional search dialog box 28. As is typical of other search applications, the search dialog box 28 enables users to enter a search term or terms in order to commence a new search. By way of example, the broad search term “BMW” is entered into the dialog box 28 for a searcher perhaps seeking to search the automobile BMW or BMW parts. Subsequently, an execution button 30, in this example labeled “Find it”, is selected to commence the search using a search provider.

Also included in the search commencement region 27, in accordance with the present invention, is a “windows” box 31 with a pull down menu 32 that permits the user to explicitly designate the number of windows opened (four windows in FIG. 4, by way of example) for display the search results uncovered. In the preferred form, the VUI 20 defaults to “4” windows should the user not elect to make any changes. Such an example is the four independent windows 22a-22d displayed FIG. 2. However, referring back to FIG. 4, the user may select the number of window desired to be displayed. Using their cursor, they may “left” click on the “windows” box 31 for display of a pull-down menu 32. As shown in this example, this menu 32 provides five even number selections of window displays, i.e., “2”, “4”, “6”, “8” or “10” windows. The user simply highlights the number of windows that they desire to be opened.

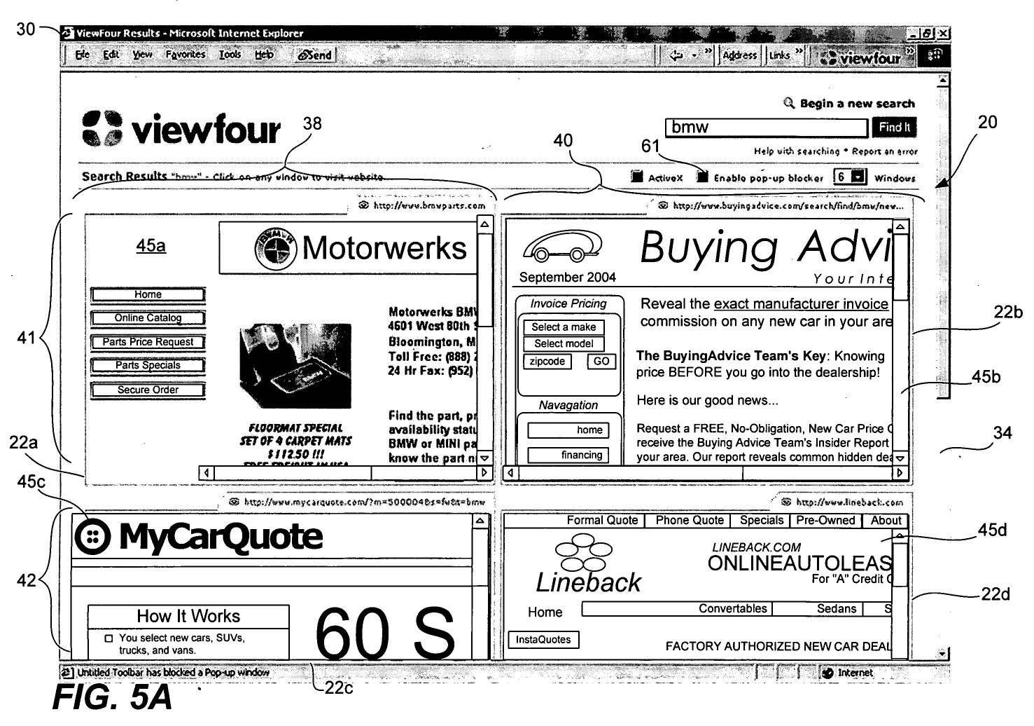

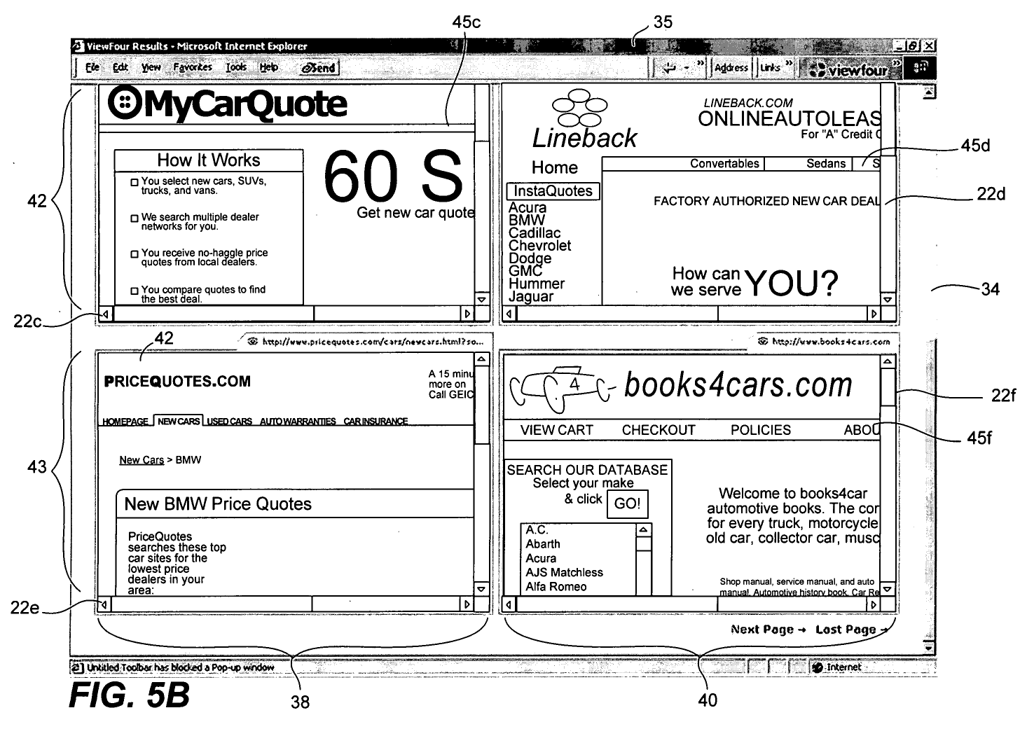

By way of example, FIGS. 5A and 5B illustrate six display windows (i.e., windows 22a, 22b, 22c, 22d, 22e and 22f) that have been simultaneously opened. It will be appreciated that while the six display windows could be proportionately sized to all fit within one screen of the browser 35 (e.g., without any scrolling), in this example, the individual window sizes (i.e., the horizontal and vertical sizes) are maintained at least the same size as the display window in the four window display arrangement of FIG. 2. Moreover, depending upon the screen resolution and how much viewing space is provided by the browser, etc., the height and width of each viewing portion may be increased, as shown in FIGS. 5A and 5B. In either instance, to view the remaining windows, the browser scroll bar 34 will have to be manipulated.

It will be appreciated that the VUI of the present invention may be configured to enable an odd number of windows display, or more than ten display windows. For example, in an odd number configuration, three independent windows could open with all three windows located in one row or one column. Conversely, in another three window configuration, the two windows could be located in one column, while the third window is located in a second column. In yet another example, one window could be sized larger than the remaining two windows. For instance, the larger window may be reserved for the first search result returned by the search provider.

In another specific configuration, the VUI 20 of the present invention will default to two display windows (i.e., in two separate rows) when it is determined the resolution of the user's screen display is less than or equal to 800×600 pixels. Since most conventional browsers occupy a predetermined amount of vertical space, a 600 pixel height limitation, in general, would be insufficient to permit legible display of more than one row 41 at a time. Accordingly, using conventional web browser screen size determination techniques, the VUI is capable of scanning the user's monitor properties to determined the screen resolution, while the server returns the appropriate results and properly formatted page to display the same. By way of example, any screen resolution of 800×600 pixels and below will default to “2” windows, although other screen display selections may still be permitted through operation of the “windows” box 31 with a pull down menu 32.

In contrast, when a screen resolution of greater than 800×600 is determined, the VUI of the present invention will default to “4” windows, but will permit the user to select any of the other number buttons displayed in the pull-down menu 32. For instance, as displayed in the informational section 33 of FIG. 4, the screen resolution was determined to be 1024×768, and hence, sufficient to permit the four or more window selection choices.

As previously indicated, and as shown in FIG. 4, a user typically enters a search term into the search dialog box 28 (e.g., “BMW”), and then “left” clicks the “Find it” button 30 to commence the search. Referring now to FIG. 2, should the “window” box 31 default to or be set at “4” windows, the representative VUI 20 is opened to display the search results. In this example, four independent display windows 22a-22d, each of which presents a home page of a website that corresponds to a search result, are all displayed within a single browser window 35.

In the illustrated embodiment, the four windows 22a-22d are aligned in an array, and are separated by a single row delimiter 36 and a single column delimiter 37. Since most viewing monitors are currently 4:3 ratio displays, a two column 38 and 40 arrangement would likely be the most acceptable. Hence, should the selection of opened windows be “2”, “6”, “8” or “10”, the number of columns 38 and 40 are likely to remain the same, while the number of two columned rows will increase. By way of example, the six display windows 22a-22f of FIGS. 5A and 5B are arranged in three rows 41, 42 and 43 of columns 38 and 40. It will be appreciated that more than two columns may be displayed, but this may not be visually feasible unless a larger screen with higher resolution is provided.

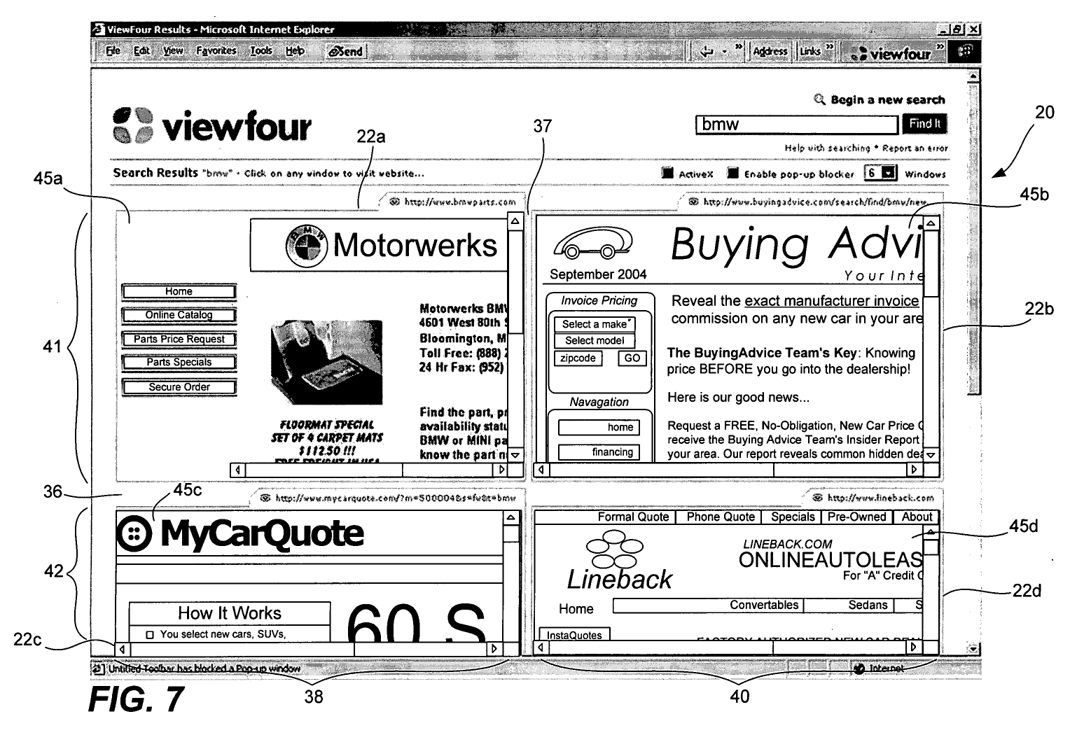

Preferably, the VUI 20 is arranged to automatically dictate the width and height of a respective viewing portion 45a-45f of the displayed windows 22a-22f in each column in terms of a percentage or number of pixels of the width of the browser window 35 so that the actual width and height of the displayed windows will vary in an appropriate way based on the general width of browser window 35. Thus, if the width and height of the browser window 35 is increased or decreased by the user, the actual widths and heights of the displayed windows 22a, 22c and 22b and 22d, respectively, in the two adjacent columns 38, 40 and rows 41, 42 (shown in FIGS. 5 and 7) will be proportionally changed accordingly, while their relative widths and heights remain the same. Although the proportional window width approach is generally preferred, it should be appreciated that in alternative embodiments, a wide variety of other window sizing rules and/or constraints may be used in its place. Although a specific resizing formula is described, it should be appreciated that a wide variety of other resizing formulas may be used as well.

The specific sizing of the windows allows precise click-through tracking along with the creation of the ‘mask’ so as to not allow navigation within the window itself (other than horizontal and vertical scrolling). The specific sizing of the windows also permits maximizing the display area of each site without being too wide. If the display window is too wide, web sites with dimensions that are less than the width of body portion of width will not be scrollable and will disrupt our ability to mask the screen.

In still another specific embodiment, the relative widths of each column and the height of each row may be manually adjusted by the user. By way of example, as shown in FIG. 7, a simple conventional click and drag operation on the column delimiter 37 and/or row delimiter 36 may be used to adjust the width and height of the display window 22a-22d. That is, the height of a particular display window (windows 22a, 22b in FIG. 7) may be expanded to increase the viewing area of the viewing portions 45a, 45b to by grabbing (e.g. clicking on) the row delimiter 36 that marks an associated window boundary and dragging the row delimiter to the desired height before releasing the click. Similarly, the width of a window (not shown) may also be increased by clicking on the column delimiter 37 dragging it to the desired width before releasing the click. It should be appreciated that when the height of one row (e.g., row 41) and/or the width of one column (not shown) are increased (or decreased) in this manner, the corresponding height of the other display windows 22c, 22d (in row 42) adjacent and on the other side of the row delimiter 36 will be reduced by a corresponding amount. This holds similarly true for the width of the display windows (not shown) on the other side of the column delimiter 37. Of course, a number of other gestures and/or interfaces may be used to give the user control over the width of the various windows. For example, a button or pull down menu could be provided that when selected causes a dialog box to be presented that permits the user to explicitly designate the relative window widths and heights.

Referring back to FIG. 2, each window 22a-22d generally includes the corresponding viewing portion 45a-45d, and a respective header tab 46a-46d in an upper right corner thereof. In the illustrated embodiment, each of the header tab 46a-46d includes a URL field 47a-47d that displays the Uniform Resource Locator, “URL”, of the web page shown in the corresponding window. By way of example, in the viewing portion 45 of the first window 22a, a fragmented view of a home page of the website bmwparts.com is displayed therein. In the header tab 45a, the corresponding URL http://www.bmwparts.com is displayed in the URL field 47a that clearly identifies the URL of website corresponding to the search result presented in the viewing portion 45a. In a similar manner, in window 22b, the URL http://www.autopartswarehouse.com is displayed in the URL field 47b that clearly identifies the URL of website corresponding to the search result presented in the respective viewing portion 45b. It should be clear that the specific search result as identified by the URL is the actual display of the contents of the URL as it exists in real-time and not a static graphical representation thereof.

It will be appreciated that the order of display of the websites in the corresponding window 22a-22d are typically based upon the order of the search results list of web pages delivered by the selected search provider. Depending upon whether the search provider delivers paid advertiser search results and/or free search results, the display order of the search results may vary. By way of example, however, the website of the first search result delivered may be positioned in window 22a, while the website of the second search result delivered may be positioned in window 22b, and so on. The order of the search results may be presented in any manner desired or deemed suitable by the search provider, whether they are based upon free search results or advertiser paid search results, the order of which is based upon what advertiser is willing to pay the most per word selected.

In accordance with one specific embodiment of the present invention, the VUI 20 may be configured to enable the user to independently scroll through and view content contained on the entire web page on the corresponding window 22a-22d. Hence, any section of the web pages illustrated in the viewing portion 45a-45d of the display windows 22a-22d can be independently viewed and scrolled to by the user. It will be appreciated, however, that the initial display of the front web pages will still be the upper left comers portions of the site.

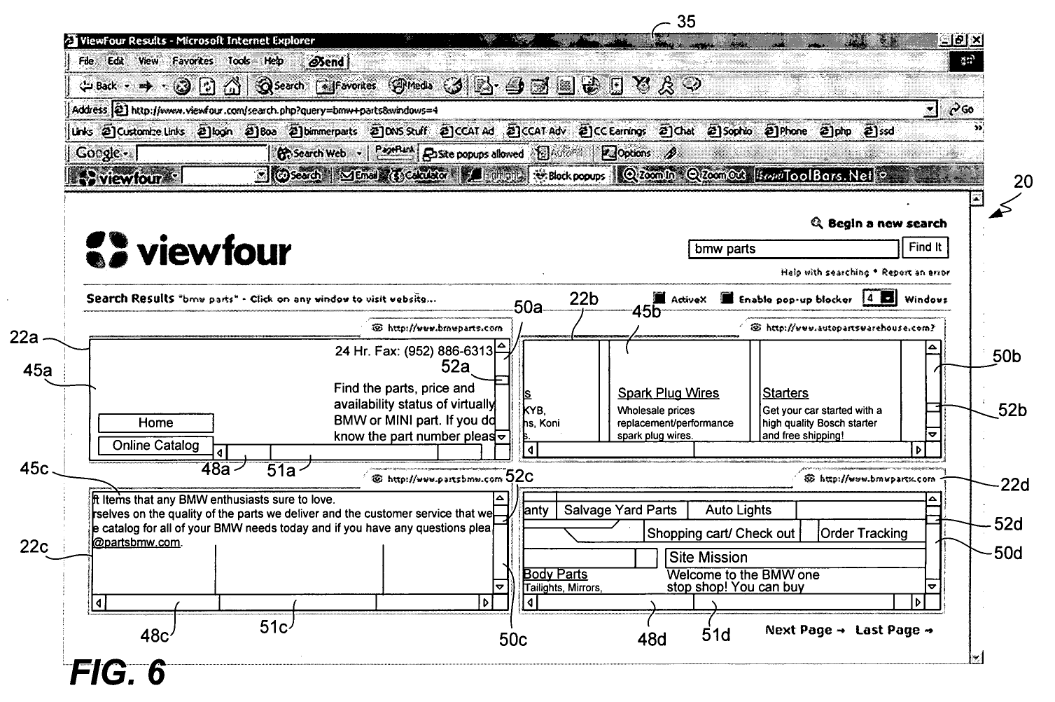

Such scrolling features are advantageous since the independent display windows 22a-22d are typically not of a window size capable of full horizontal and/or vertical display of the web page. Independent viewing and scrolling of the entire website is readily accomplished by providing appropriate GUI scrolling tools or widgets. These scrolling tools are incorporated within the respective window 22a-22d, and enable viewing and scrolling of the content of the selected web page displayed in the viewing portion 45a-45d of corresponding display window. As best viewed in FIGS. 2 and 6, the scrolling tools may include a conventional horizontal scroll or slider bar 48a-48d oriented in a footer region of each window, while a conventional vertical scroll or slider bar 50a-50d is oriented in a rightmost or column region of each window.

Typical of these scrolling tools, a user can apply the cursor to selectively manipulate the position of horizontal and vertical slider buttons 51a-51d, 52a-52d of the respective horizontal and vertical scroll bars 48a-48d, 50a-50d to horizontally and vertically scroll the front web page in the viewing portion 45a-45d of the respective window 22a-22d. By way of example, as shown in FIG. 6, the slider buttons 51 a and 52a of the first window 22a have been operated to scroll along to different portions of the web page. In other embodiments, the scroll bars may be replaced or supplemented by other GUI widgets, as for example, a user defined ‘skin’. Further, the viewing portions 45a-45d of the respective display windows 22a-22d may be viewed and scrolled using the conventional scroll wheel functions of a mouse (not shown). By merely placing their cursor over the selected window, operation of the scroll wheel scrolls through the contents of the corresponding viewing portion.

In another specific embodiment, additional website information may be acquired by positioning the cursor over one of the display windows 22a-22d. After a predetermined time, such an action causes a tool tip (not shown) to display which contains additional information relating to the underlying website that is being displayed in the respective display window. Preferably, this tool tip information incorporates the website summary information generally provided by the underlying website itself.

Should another search be desired from the search results page 21, the user need not return back to the home page 26 shown in FIG. 4. As shown in the search results page 21 of the VUI 20 of FIGS. 2 and 5A, a search dialog box 53 is provided that permits the user to enter a search term or terms in order to commence a new search. Similar to the home page 26 of the VUI 20, once the selected terms are typed into the search dialog box 53 (e.g. “BMW”), the user can operate a search execution button 55 to commence a new search. In this instance, the search execution button 55 is again labeled “Find it”.

The user may also change the number of windows displayed from the search results page 21, either for when conducting a new search or for when re-displaying an existing search in a different number of display windows. Again, similar to the home page 26, the search results page 21 includes a “windows” box 56 that permits the user to explicitly designate the number of display windows to be opened (e.g., six windows as shown in FIG. 2) to view the search results. Manipulating the cursor, the user may “left” click on the “windows” box 56 which displays a pull-down menu 57 that contains the window number of selections for display (i.e., “2”, “4”, “6”, “6” or “10”, windows). The user again simply highlights the number of windows that they desire to be opened. Again, by way of example, FIGS. 5A and 5B illustrate six windows that have been simultaneously opened (i.e., windows 22a, 22b, 22c, 22d, 22e and 22f).

In the event the user desires to view more search results, the search results page 21 of the VUI 20 includes a set of page buttons located in the lower right portion thereof. Referring back to FIG. 2, a “NEXT PAGE” button 58 can be selected or manipulated by the user to advance or page the search result forward to display the next set of websites corresponding to the search results on the display windows 22a-22d of the VUI 20. In a similar manner, operation of a “LAST PAGE” button 60 enables the user to page back to the previous set websites displayed.

When the page buttons 58, 60 are selected for page advance or page reverse, the VUI will continued to display the same number or set of display windows selected when the corresponding search was commenced. For example, in the search conducted in FIG. 2, a page advance or page reverse will continue to advance and retract in sets of four windows 22a-22d. Likewise, in the search conducted in FIGS. 5A and 5B, a page advance or page reverse will continue to advance and retract in sets of six windows 22a-22f.

In another aspect of the present invention, pop-up blocking technology is incorporated to block or prevent pop-ups from opening and displaying when an underlying website is accessed. Pop-up technology is not only a detriment to system performance and inherent operating system security flaws, but is a significant annoyance to the user as well. Hence, blocking pop-ups is particularly imperative since the problems caused are actually magnified due to the nature of the present invention. As above-mentioned, in certain arrangements, ten or more websites can be opened simultaneously or in succession.

The pop-up blocking technique is achieved by the user downloading a small program that runs in the same memory space as the browser itself. Each URL is analyzed in advance of it being displayed for pop-ups. If a URL is found to have pop-ups embedded in the code, the URL is not automatically displayed, but rather hidden from the user's search results.

Further, in some implementations of the present invention, the use of the following html tag is incorporated to prevent pop-ups [security=“restricted”]. Use of this tag relates only to certain web browsers such as Microsoft's Internet Explorer.

It will be appreciated that in most arrangements, the pop-up ad blocking technology will be automated and integrated within the VUI of the present invention. By simply operating the search dialog boxes 28, 53 of the home page 26 and the search results page 21, respectively, the pop-up ad blocker is automatically enabled and functional with the help of the [security=“restricted”] property. In other specific arrangements, however, selective operation of the pop-up ad blocker may be incorporated. Hence, the ad blocker feature can be turned on or off at the user's discretion. (I am not aware of such a function. And I see no need ever for such a function) Such selective operation may be advantageous, for example, when a search is exhausted and the user is concerned that a result may be relevant and having a pop-up associated with it. Referring to FIGS. 2 and 4, for example, a pop-up blocker enablement box 61 may be provided for simple selective enablement thereof. Intuitively, a user need only check the enablement box 61 with their cursor to commence operation of the blocker technology.

In another specific implementation of the present invention, the use of the following html tag [security=“restricted”] is also incorporated to prevent website takeovers. In other words, this tag may be applied to prevent third party websites from forcing an application to automatically open the third party website without an active click by the user. Some third websites have code that specifically will maximize their front page. In the present invention, where multiple web pages are simultaneously opened for display in the windows 22a-22d, the user would be forced to view, in a new opened browser window, these third party web pages rather than being able to choose which sites to open from VUI 20 by clicking on the associated display window. The addition of this code [security=“restricted”] prevents this unwanted behavior.

In yet another aspect of the present invention, a computer implemented method is provided for displaying search results on a client system. Briefly, the client system is in connection to a computer network, and the computer network includes at least one content provider server and at least one intermediate server. The method includes receiving a search request from the client system. The search request includes at least one search term relating to a search topic. The method further includes processing the search request, wherein the processing of the search request includes retrieving search results. The search results include a plurality of associated URLs corresponding to a plurality of web pages. The method according to the present invention further a first portion of the search results to the client system, the first portion including a first portion of URLs of the plurality of URLs, and causing the client system to retrieve web page content associated with a first portion of URLs of the plurality of URLs. Finally, the method includes causing the client system to display, via a graphical user interface, the search results according to a first specified format. The first specified format includes a plurality of windows, each window displaying web page content associated with a respective web page of the first portion of URLs.

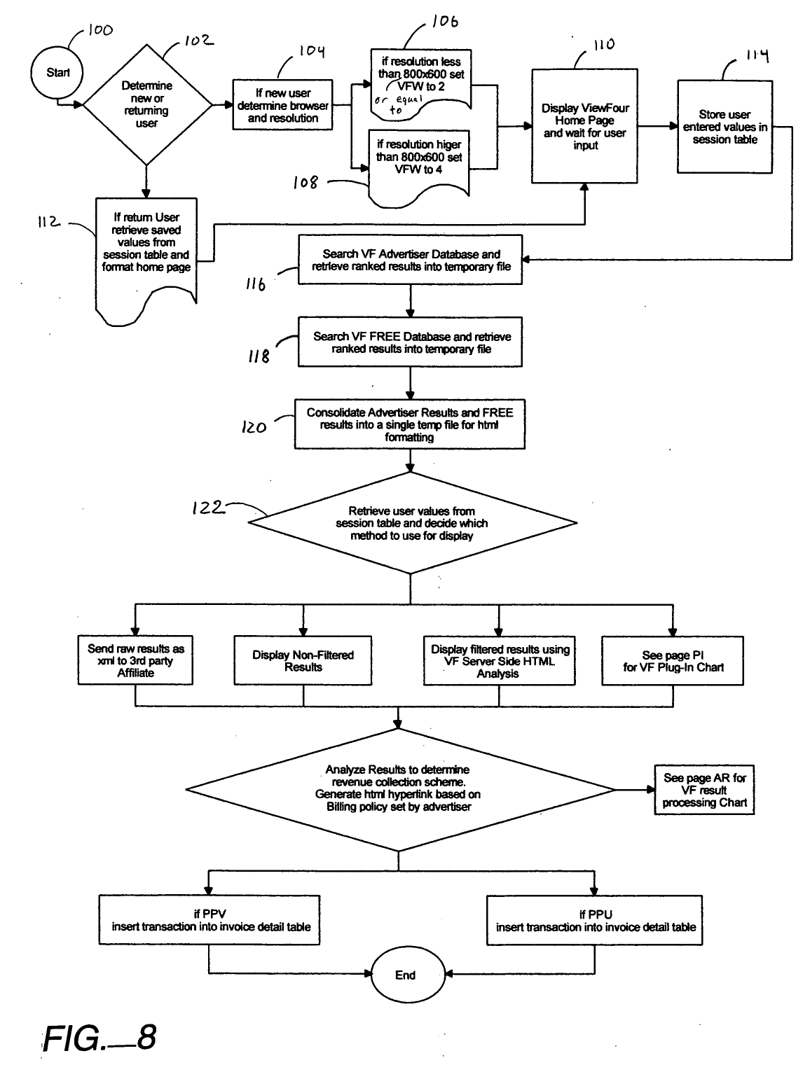

More definitively, as best viewed in FIG. 8, a flow diagram is provided. As mentioned, the present invention operates over a computer network (preferably the internet) that includes a client system (the user), at least one content provider (a website corresponding to a search result) and at least one intermediate server (e.g., the Viewfour server which could include the search provider server). At the Start 100 of the methodology, it is initially determined at 102 whether the user is a new user or a returning user of a client system. Employing conventional identifier data, when a user initially attempts to enter the home page 21 of the intermediate server, this data is accessed to determine whether the user is a returning user from a specific IP address and cookie. As is well known in the field, such identifier data is typically in the form of a cookie, or data file stored on the client system and accessible by the technology described herein.

At 104, in the event a new user (or new IP address) is detected, the client system's display device is scanned to determine the current display resolution. As mentioned above, conventional screen scanning methods are applied to determine the resolution of the screen. Should the resolution be determined to be less than or equal to 800×600 pixels, at 106, the number of display windows 22 of the VUI 20 defaults to two side-by-side windows 22a, 22b. However, at 108, should the screen resolution be determined to be greater than 800×600 pixels, the number of display windows defaults to four windows 22a-22d aligned in an array, such as shown in FIG. 2.

Subsequently, at 110, the actual home page 26 of the intermediate server is displayed, as shown in FIG. 4. The VUI 20 then awaits data input by the user from their remote client system before commencing a search. Such data input includes the user selection of the number of display windows using the “windows” box 31, if different from the default values. This data input also includes the user selected search terms that are typed into the search dialog box 28.

At 114, this data input, along with the client identification data, and their corresponding screen resolution determined window default settings are stored in a session table file. This storage event preferably occurs when the user executes the “Find It” button 30. This session table is stored on the database server of the search provider for general access when the user returns to the VUI home page 26.

Accordingly, referring back to 102, if it has been determined that the user is a return user, via the identifier data, the user's previously stored session variables are retrieved from the session table and communicated to the users terminal. In the session table, the data relating to the default number of display windows is retrieved and applied to format the home page. Subsequently, the URL result is displayed at 110.

Returning back to session table data storage event at 114, once the user executes the “Find It” button 30, the search term or terms of a search topic is transmitted to and received by the Intermediate server that contains the database of search terms necessary for processing of the network based computer search. The intermediate server retrieves the search results from either their own database or an outsourced search provider. These searches can also include an advertiser based database as well as the free listing database. These returned search results include a plurality of URL's corresponding to the advertiser's web page and/or the web page of the free results.

A first portion of these URL's is processed and an html page is created at the Intermediate server. This page is transmitted to the client system together with the first portion of URLs. The client system is then caused to render the results inside their web browser and displays the content of the corresponding web pages in an associated window accordingly. The web pages references are automatically navigated too by the user's browser in real time. In the current embodiment this is the most effective and productive means to accomplish the task.

In another embodiment, the user is able to select which search provider is to be used for the free results search. Potential search providers include, but are not limited to: Google, Yahoo, MSN, Ask Jeeves, or any other publicly available search engine or website. In this embodiment, the initial search is performed, and the advertiser database of the Intermediate server is searched for potential matches on the supplied keyword. If any results are found a temporary file is created on the client system. A second search is then performed on the search providers server by accessing either their website directly or via an XML or other data feed. The supplier keyword is sent and the results from the search provider's database are returned to another temporary file on the user's pc. These two files are consolidated similarly to the current invention, and then the results are displayed in the user's browser in a similar fashion as the current embodiment. In other embodiments, the user may be able to initially control and adjust the ranking of the sites to enhance the results. Some enhancements may include the excluding of sites that have the keyword in the URL (due to potential spamming), or excluding the sites due to potential malware (a term used to describe software that is a potential security threat), to name a few. Further, the user may opt to sort the results by domain name, or website title/description. This version may be referred to as the ‘user side’ version, vs. the ‘server side’ version.

As mentioned above, most search engines and website directories generally provide a searchable database that assigns search results to selected keywords. Moreover, most search providers offer both a free database of search results and an advertiser based (paid) database of results, these results are consolidated and ranked by the search providers ranking algorithm. In accordance with the present invention, both databases will be searched.

Generally, however, referring back to FIG. 8, at 116, the advertiser search database (of either the intermediate server or an outsourced search provider server) is searched using the user selected search term(s) of the search topic. Depending upon the search providers, the returned order of the search results can be based upon any rank or order scheme. The VUI 20 of the present invention, however, stores these retrieved ranked results in a temporary file on the intermediate server. Similarly, at 118, the free search database is searched using the user selected search terms, which when retrieved are likewise stored in the rank and order received from the search provider. These free search results are also in the temporary file together with the advertiser search results on the intermediate server.

It will be appreciated that the order of the advertiser search results and the free search results are not important, and may be reversed. Further, in instances where the search provider does not distinguish between databases, or categorizes their database differently, the present invention can likewise be adapted to suit the categorization of the search provider.

At 120, the advertiser search results and the free search results are consolidated into a single temporary file stored on the intermediate server. The rank and order presentation of the consolidated search results can be arranged under any scheme or formula. Preferably, however, the search provider determines the order of the consolidation.

In other arrangements, the file consolidation at 122 may not be necessary or desirable. For example, the VUI 20 of the present invention can be configured to split the advertiser search results into one column or row, and orient the presentation of the free search results in the other column or row of the array of multiple display windows. In such an instance, the advertiser search results and the free search results are maintained separate from one another.

Once the file consolidation is completed, the intermediate server generates an html file that is rendered by the user's web browser. An html file template renders the first portion of URLs of the plurality of URLs corresponding to the search results in a consistent format for display in an html capable web browser that supports version 4.0 or great of the W3C (World Wide Web Consortium).

Although only a few embodiments of the invention have been described in detail, it should be appreciated that the invention may be implemented in many other specific forms without departing from the spirit or scope of the invention. For example, the search terms can be highlighted in the content displayed in the windows for easier viewing.

Further, in the illustrated embodiments, the selectable number of open windows is typically limited to a minimum of two windows and a maximum of ten windows. This is often preferable because if too many windows are open at one time, it not only decreases the paging performance since more than ten web pages would require loading, but it also becomes difficult to easily scroll through all those pages. However it should be appreciated that in some specific applications, it may be desirable to permit the user to open more than ten windows simultaneously.

In the described embodiments the various display windows are arranged in an array of even numbered adjacent rows and columns. This approach has been found to be an intuitive and visually appealing way to efficiently display multiple web pages. However, in alternative embodiments, the geometry and arrangement of the various windows may be adjusted to meet the needs of a particular situation. For example, in some situations it might be desirable to arrange all of the windows in one horizontal row or one vertical column. In other situations it might be desirable to split windows into more than two columns. In specific applications, other window layouts could be used as well.

It will further be appreciated that search results VUI is well adapted for presenting a wide variety of search results in virtually any combination of search categories and search related information. The searches may be general web type searches, searches of proprietary databases (such as trademarks and patents), searches of a single website or searches of a wide variety of other content either alone or in any desired combination. The search results categories can be independent of each other, they may be interrelated sets or subsets or any other combination.

It should be apparent that there is no need for the described search results VUI to be “open” or rendered before a search is performed. Thus, it should be appreciated that the user may enter a search request using any conventional search dialog box or other appropriate search entry mechanism. By way of example, FIG. 4 illustrates one suitable interface for entering an initial search request. Of course, search requests may be entered using other search dialog boxes such as those illustrated in FIGS. 2 and 5A or any other suitable mechanism.

In many implementations, the search provider will dictate the specific order of the presentation of the search results by order of the search results list provided. However, it should be appreciated that the described interface is also well suited for use in implementations where the user is given control over the presentation order, such as categorical and/or sub-categorical order presentation of information being searched. Therefore, the present embodiments are to be considered as illustrative and not restrictive and the invention is not to be limited to the details given herein, but may be modified within the scope of the appended claims.

What is claimed is:

1. A graphical user interface for displaying at least two search results from a plurality of search results identified during a network based search, said graphical user interface comprising:
a first window configured to display at least a first viewing portion of a first web page associated with a first search result of the plurality of search results; and
a second window configured to display at least a second viewing portion of a second web page associated with a second search result of the plurality of search results,
wherein said first viewing portion and said second viewing portion each comprise at least a predetermined width and height of a browser window based upon the resolution of the user's screen.

2. The graphical user interface according to claim 1 wherein
said first and second viewing portions comprise the upper left corner of the corresponding of the first and second web pages.

3. The graphical user interface according to claim 2 wherein
the predetermined width is in the range of at least about 400 pixels to about 700 pixels, and the predetermined height is in the range of at least about 100 to about 240 of the height of the browser window.

4. The graphical user interface according to claim 1 wherein
the first window is configured to enable the user to independently scroll through and view the remaining content contained on the first web page; and
the second window is configured to enable the user to independently scroll through and view the remaining content contained on the second web page.

5. The graphical user interface according to claim 4 wherein
at least one window includes a scrolling tool that facilitates independent viewing and scrolling of the contents of the associated window.

6. A graphical user interface according to claim 5 wherein
the scrolling tool includes a scroll bar.

7. The graphical user interface according to claim 6 wherein
each window includes at a vertical scroll bar when the corresponding window is of an insufficient size to display the entire vertical content of the corresponding web page, and at a horizontal scroll bar when the corresponding window is of an insufficient size to display the entire horizontal content of the corresponding web page.

8. The graphical user interface according to claim 1 wherein
the windows are arranged in adjacent columns, and the interface further comprising a column delimiter that visibly marks the boundaries between adjacent windows.

9. The graphical user interface according to claim 8, wherein
said column delimiter is adjustable.

10. The graphical user interface according to claim 1 further including:
a third window configured to display at least a third first viewing portion of a third web page associated with a third search result of the plurality of search results, wherein said third viewing portion being sufficiently sized to enable the user to substantially determine the generally search relevancy of the third search result; and
a fourth window configured to display at least a fourth viewing portion of a fourth web page associated with a fourth search result of the plurality of search results, wherein said fourth viewing portion being sufficiently sized to enable the user to substantially determine the generally search relevancy of the fourth search result.

11. The graphical user interface according to claim 10 wherein
the first, second, third and fourth viewing portions each comprise the upper left corner of the corresponding of the web pages.

12. The graphical user interface according to claim 10 wherein
the first, second, third and fourth windows are each configured to enable the user to independently scroll through and view the remaining content contained on the corresponding web page.

13. The graphical user interface according to claim 12, wherein
the windows are arranged in an array of adjacent columns and adjacent rows, the interface further comprising one of at least one column delimiter and at least one row delimiter that visibly mark the boundaries between adjacent windows.

14. The graphical user interface according to claim 13, wherein
said column and row delimiters are adjustable.

15. The graphical user interface according to claim 1 further including:
a paging tool that enables the user to page advance or page retract to a third web page associated with a third search result of the plurality of search results for display on said first window, wherein the user may independently scroll through and view content contained on the third web page; and to advance or retract to a fourth web page associated with a fourth search result of the plurality of search results for display on said second window, wherein the user may independently scroll through and view content contained on the fourth web page.

16. The graphical user interface according to claim 1 further including:
a “windows” quantity selector enabling a user to select the number of windows for the simultaneous display of the at least two websites corresponding to the selected number; and

17. The graphical user interface according to claim 16 wherein
said quantity selector being configured to enable the user to select between two to ten independent windows for said simultaneous display.

18. The graphical user interface according to claim 17 wherein
said quantity selector being configured to enable the user to select an even number of independent windows.

19. A graphical user interface for simultaneous display of at least two websites associated with search results identified during a network based search, said graphical user interface comprising:
a quantity selector enabling a user to select the number of windows for the simultaneous display of the at least two websites corresponding to the selected number; and
the selected number of windows each configured for display of a web page associated with a corresponding search result, wherein a user may independently scroll through and view the content contained on each web page.

20. The graphical user interface according to claim 19 wherein
said quantity selector being configured to enable the user to select up to ten independent windows for said simultaneous display.

21. The graphical user interface according to claim 19 wherein
said quantity selector being configured to enable the user to select an even number of independent windows from two to ten.

22. The graphical user interface according to claim 21 wherein
said quantity selector is in the form of a pull-down menu.

23. The graphical user interface according to claim 21 wherein
at least four independent windows are simultaneously displayed, and
the windows are arranged in one of adjacent columns and adjacent rows, the interface further comprising one of at least one column delimiter and at least one row delimiter that visibly mark the boundaries between adjacent windows.

24. The graphical user interface according to claim 23 wherein
at least one window includes a scrolling tool that facilitates independent viewing and scrolling of the contents of the associated window.

25. The graphical user interface according to claim 24 wherein
the scrolling tool includes a scroll bar.

26. The graphical user interface according to claim 25 wherein
each window includes at a vertical scroll bar when the corresponding window is of an insufficient size to display the entire vertical content of the corresponding web page, and at a horizontal scroll bar when the corresponding window is of an insufficient size to display the entire horizontal content of the corresponding web page.

27. The graphical user interface according to claim 19 wherein
the windows are arranged in one of adjacent columns and adjacent rows, the interface further comprising one of at least one column delimiter and at least one adjustable row delimiter that visibly mark the boundaries between adjacent windows.

28. The graphical user interface according to claim 19 wherein
at least one window includes a scrolling tool that facilitates independent viewing and scrolling of the contents of the associated window.

29. The graphical user interface according to claim 28 wherein
the scrolling tool includes a scroll bar.

30. The graphical user interface according to claim 29 wherein
each window includes at a vertical scroll bar when the corresponding window is of an insufficient size to display the entire vertical content of the corresponding web page, and at a horizontal scroll bar when the corresponding window is of an insufficient size to display the entire horizontal content of the corresponding web page.

31. The graphical user interface according to claim 19 further including:
a web page advance tool that enables the user to selectively advance the content displayed in the at least two windows to a second set of web pages, each corresponding to an associated search result from the search.

32. A computer implemented method for displaying search results on a client system, the client system being in connection to a computer network, the computer network including at least one content provider server and at least one intermediate server, the method comprising:
receiving a search request from said client system, the search request including at least one search term relating to a search topic;
processing the search request, wherein the processing of the search request includes retrieving search results, the search results including a plurality of URLs corresponding to a plurality of web pages;
providing a first results portion of the search results to the client system, the first results portion including a first portion of URLs of the plurality of URLs;
causing the client system to retrieve web page content associated with a first portion of URLs of the plurality of URLs; and
causing the client system to display, via a graphical user interface, the search results according to a first specified format, wherein the first specified format includes a plurality of windows, each window displaying web page content associated with a respective web page of the first portion of URLs.

33. A system for displaying search results on a client system, the client system being in connection to a computer network, the computer network including at least one content provider server and at least one intermediate server, the system comprising:
at least one processor;
at least one interface configured or designed to provide a communication link to at least one other network device in the data network; and
memory;
the system being configured or designed to:
receive a search request from said client system, the search request including at least one search term relating to a search topic;
process the search request, wherein the processing of the search request includes retrieving search results, the search results including a plurality of URLs corresponding to a plurality of web pages;
provide a first results portion of the search results to the client system, the first results portion including a first portion of URLs of the plurality of URLs;
cause the client system to retrieve web page content associated with a first portion of URLs of the plurality of URLs; and
cause the client system to display, via a graphical user interface, the search results according to a first specified format, wherein the first specified format includes a plurality of windows, each window displaying web page content associated with a respective web page of the first portion of URLs.

34. A computer program product for displaying search results on a client system, the client system being in connection to a computer network, the computer network including at least one content provider server and at least one intermediate server, the computer program product comprising:
a computer usable medium having computer readable code embodied therein, the computer readable code comprising:
computer code for receiving a search request from said client system, the search request including at least one search term relating to a search topic;
computer code for processing the search request, wherein the processing of the search request includes retrieving search results, the search results including a plurality of URLs corresponding to a plurality of web pages;
computer code for providing a first results portion of the search results to the client system, the first results portion including a first portion of URLs of the plurality of URLs;
computer code for causing the client system to retrieve web page content associated with a first portion of URLs of the plurality of URLs; and
computer code for causing the client system to display, via a graphical user interface, the search results according to a first specified format, wherein the first specified format includes a plurality of windows, each window displaying web page content associated with a respective web page of the first portion of URLs.

35. A method of displaying computerized search results from a network based search on a searchers display device comprising:
receiving a search request from a searcher;
performing a search, based upon the search request, to obtain a plurality of search results, each search result being associated with a corresponding web page;
simultaneously displaying on the display device at least two windows each containing a web page corresponding to an associated search result from the search.

36. The method according to claim 35, further including
receiving user scrolling instructions to independently enable scrolling through and viewing content contained on the respective displayed web page.

37. The method according to claim 36, wherein
said scrolling instructions includes accepting input from a user operated scrolling tool.

38. The method according to claim 37, wherein
the scrolling tool includes a scroll bar.

39. The method according to claim 37, wherein
receiving user page advance instructions to selectively advance the content displayed in the at least two windows to a next set of web pages, each corresponding to a next set of associated search results from the search.

40. The method according to claim 35, further including:
introducing a vertical scrolling tool when the corresponding window is of an insufficient size to display the entire vertical content of the corresponding web page, and
introducing a horizontal scrolling tool when the corresponding window is of an insufficient size to display the entire horizontal content of the corresponding web page.

41. The method according to claim 40, wherein
the scrolling tool includes a scroll bar.

42. The method according to claim 35, further including:
arranging the windows in one of adjacent columns and adjacent rows, and
positioning at least one adjustable column delimiter and at least one adjustable row delimiter that visibly marks the boundaries between adjacent windows.

43. The method according to claim 35, further including:
before the receiving a search request, enabling the user to select the number of windows for said simultaneous display on the display device.

44. The method according to claim 43, wherein
said enabling the user further includes receiving a user selection input from the user.

45. The method according to claim 35, further including:
displaying the search results on the at least two display windows in an order determined by the order of the plurality of search results returned.

46. The method according to claim 35, further including:
displaying the search results on the at least two display windows in an order random from the order of the plurality of search results returned.

47. A graphical user interface for displaying at least two search results from a plurality of search results identified during a network based search, said graphical user interface comprising:
a first window configured to display a first web page associated with a first search result of the plurality of search results, wherein a user may independently scroll through and view content contained on the first web page; and
a second window configured to display a second web page associated with a second search result of the plurality of search results, wherein the user may independently scroll through and view content contained on the second web page.
